(19) United States
(12) Patent Application Publication
(10) Pub. No.: US 2022/0134937 A1
(43) Pub. Date: May 5, 2022

(54) Apparatus for a beam supporting rail

(71) Applicant: Nathaniel Nunez, Highland, IN (US)

(72) Inventor: Nathaniel Nunez, Highland, IN (US)

(21) Appl. No.: 17/087,223

(22) Filed: Nov. 2, 2020

(51) Int. Cl. B60P 7/08

(52) U.S. Cl. CPC B60P 7/0815

(57) ABSTRACT

An apparatus useful for providing a surface upon which heavily weighted material can rest or come to rest. The apparatus can be easily attached to a beam support rail system. One such system having a channel with notches or hips that are used to locate load bars, beams, that engage the hips at various heights, or other positions if not vertical, along the rail system. In this way heavy loads can be placed on top of or against the bars. The apparatus is able to provide secondary support for the beams should a beam's support portion fail.

### CROSS-REFERENCE TO RELATED APPLICATIONS

The present application claims the benefit of U.S. Provisional Patent Application No. 62/937,638 filed on Nov. 19, 2019, the entirety of which is hereby incorporated by reference.

### BACKGROUND

The trucking industry ships goods of all sorts. The weight, size, and shape of the packaging is quite varied. Carriers use different loading methods. Securement of the packages, as well as strapping blocking and bracing play an important role in preventing damaged goods. The carriers are also concerned with ease of handling and stowing the products.

One loading method used by carriers involves stacking the goods. Stacking requires creating different platforms at different levels inside the trailer. The platforms are held up by load bars. The load bars are attached to vertical rails mounted to the walls of the trailer. Packaged goods can then be loaded into the trailer below and then on top of the load bars, or beams, using palletized configurations to form platforms.

Specialized catches are used to secure the load bar to the vertical rails. These catches are crucial to the performance of the platforms placed on load bars. If a catch fails, then the bar will no longer support the platform. The goods placed on top of the platform can fall and result in damage or injury if a catch fails.

Currently, carrier operators are tasked with managing the integrity of the catches. However, drivers are often hurried at the end of their route and failed catches go un-repaired for long periods of time.

To solve this problem of a trailer having failed catches, carriers keep replacement catches on hand. Drivers are asked to manually replace failed catches as a user feels are needed. These replacement and repair responsibilities often go undone before an accident occurs with the load bar, platform, and catches/beam support portions.

There is a need in the industry for an apparatus that can be used to prevent the damage and injury that occurs when a load bar catch, a beam support portion, fails. An apparatus that will allow more time to identify and replace or repair failed catches or beam support portions.

### SUMMARY

The present invention relates to an apparatus that satisfies these needs. The apparatus comprises a catch/beam support portion which engages a rail to provide support to a beam placed on, or is part of, the beam support portion. The rail is similar to the track disclosed in U.S. Pat. No. 8,337,127B2. This is envisioned to be a durable stop that engages the same rail system that the beam support portion uses, such as that of a load securement system. The invention would be located alongside the catch and provide a pillar of support should the catch fail and the weight from the platform, in this case, falls down.

I have found that a beam support portion used for supporting a beam, two on each beam one on each end, fails after time. My invention prevents the failing portion from causing accident injuries and money loss because my invention creates a pillar of support by attaching to the beam support rail, or other similar track, and keeps the failed beam support portion from sliding down, or in any other direction if it is mounted in a non-vertical position. This means that should a beam support portion of a load bar and rail system fail; my inventive apparatus will catch and stop the beam support portion from sliding in the rail system and thereby prevent falling of the load being supported. My invention provides that the support located above my invention is prevented from sliding because my invention obstructs its path.

Too, even without damage to a beam support portion, my invention is capable of holding a clasp of the beam support portion in place and prevent unintended un-latching situations. This might be done through the use of a zip tie to keep the latching mechanism from unlatching but can be done in many ways. Similarly, vibrations occurring inside a truck, for instance, will not cause such un-latching. I've seen this work on a load securement system.

The present invention provides for an apparatus that can be removably attached to a beam supporting rail, or track, of a load securement system providing the user with a means to provide secondary support to a beam supporting mechanism should any failure occur. The apparatus includes a support body, at least one resting portion, and at least one anchoring portion.

The at least one resting portion being attached to the support body. The at least one anchoring portion being attached to the at least one resting portion. The support body and the at least one anchoring portion being spaced apart by the at least one resting portion. The support body, whereby the support body may be adjoined to a beam support portion when the at least one anchoring portion is interconnected with a channel of the beam supporting rail and the at least one resting portion adjoins a hip of the channel.

An embodiment of the apparatus for beam supporting rails provides for a support body. The support body having a head portion and a clasp receiving portion. At least one resting portion having a first face and a second face. At least one anchoring portion having a third face.

It includes a fastener. The first face being attached to the support body. The third face being attached to the second face. The support body and the at least one anchoring portion being spaced apart by the at least one resting portion. An offset portion having an anchoring surface and being connected to the at least one anchoring portion. The anchoring surface extending away from the at least one resting portion. The anchoring surface being sufficiently coplanar with the third face.

The fastener being removably attached to the support body. The head portion, whereby the head portion may be adjoined to a beam support portion when the anchoring surface is interconnected with a channel of the beam supporting rail and the at least one resting portion adjoins a hip of the channel. A clasp attached to the beam support portion interconnecting with the clasp receiving portion. The fastener being capable of securing the beam support portion.

### BRIEF DESCRIPTION OF THE SEVERAL VIEWS OF THE DRAWINGS

These and other features, aspects and advantages of the present invention will become better understood with regard to the following description, appended claims, and accompanying drawings where:

FIG. 1 shows a perspective view of one embodiment of the present invention being used in a vehicle.

FIG. 2 shows a side view of an embodiment of the present invention attached to a beam support rail.

FIG. 3 shows a perspective view of an embodiment of the present invention attached to a beam support rail.

FIG. 4 shows a perspective view of an embodiment of the present invention.

### DESCRIPTION

Overview.

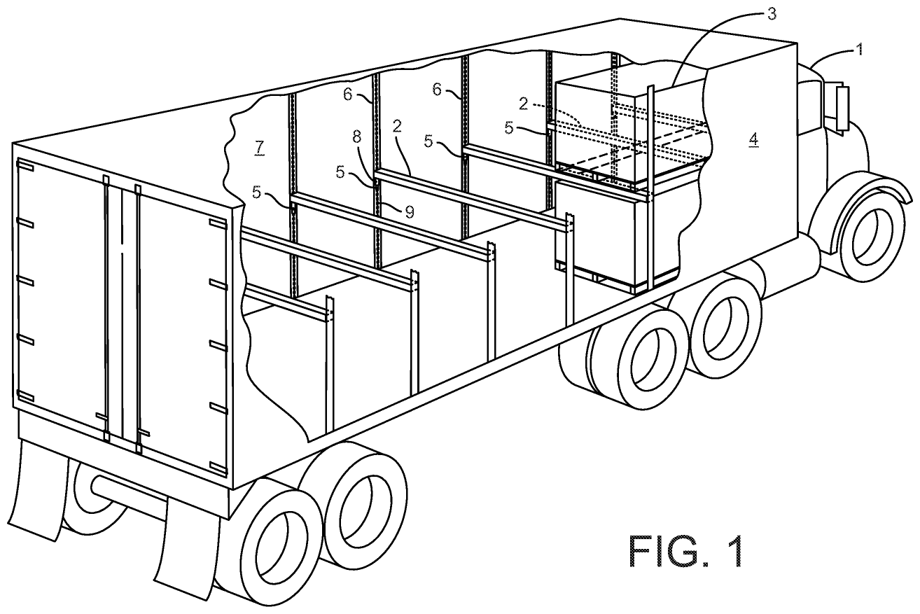

The present invention relates to an apparatus 5. As shown in FIG. 1, the apparatus 5 can be removably attached to a beam support rail 6 providing the user with a means to provide secondary support to a beam support portion 8 that is part of a beam supporting rail system, a load securement system, commonly used with transport vehicles 1 should any failure occur. Such beam supporting rail systems incorporate beams 2 that are attached, often via a beam support portion 8, to a beam support rail 6 attached to the inside wall 7 of a container 4 that is attached to, or part of, a transport vehicle 1. The beam support rail 6 having a channel with hips 9 that interconnect with the beam support portion 8. Heavy loads 3 can be placed upon the beams 2, usually after being palletized.

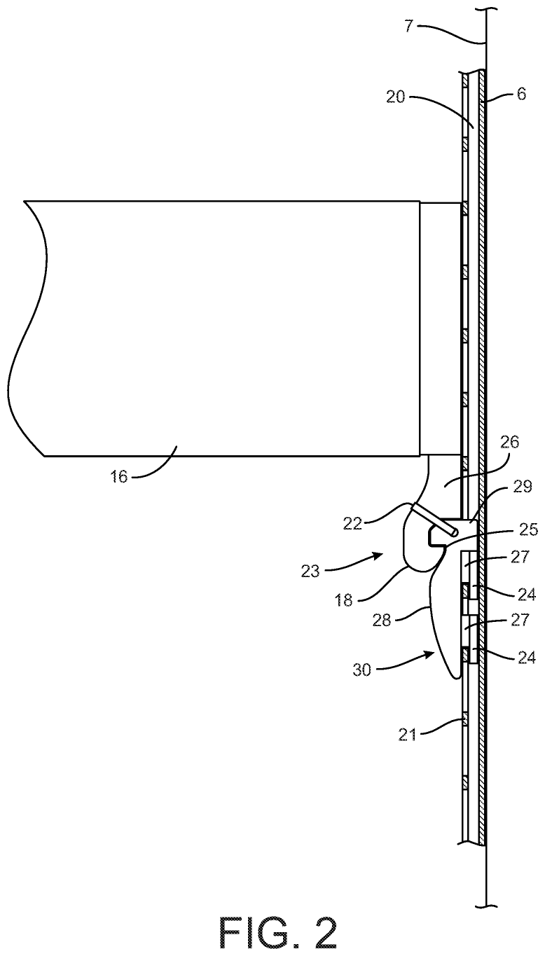

As shown in FIG. 2, a side view of an embodiment of the present invention attached to a beam support rail 6, again attached to an inside container wall 7. The embodiment includes the apparatus 30 that has a support body 28, at least one resting portion 27, and at least one anchoring portion 24. The at least one resting portion 27 being attached to the support body 28. The at least one anchoring portion 24 being attached to the at least one resting portion 27. The support body 28 and the at least one anchoring portion 24 being sufficiently spaced apart by the at least one resting portion 27. The support body 28, whereby the support body 28 may be adjoined to a beam support portion 26 when the at least one anchoring portion 24 is interconnected with a channel 20 of the beam support rail 6 and the at least one resting portion 24 adjoins a hip 21 of the channel 20.

Additionally, there is a head portion 29 which has a clasp receiving portion 25. The beam support portion 26 has a clasp 18 that clasps into the clasp receiving portion 25. The beam support portion 26 is fastened to the support body 28 via a fastener 22 attached to the support body 28 and retaining the beam support portion 26 in its latched position, shown at 23.

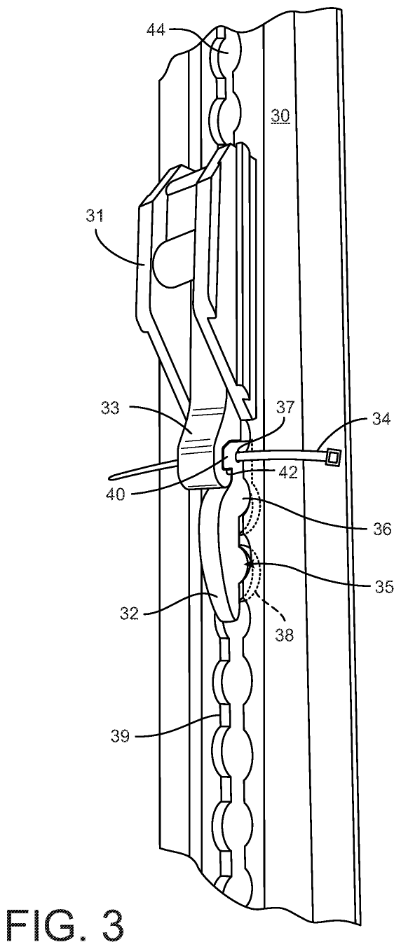

As shown in FIG. 3, a perspective view of an embodiment of the present invention attached to a beam supporting rail 30 comprises a support body 32. The support body 32 having a head portion 40 and a clasp receiving portion 42. At least one resting portion 36 and an anchoring portion 38. It includes a fastener 34. The support body 32 and the at least one anchoring portion 38 being spaced apart by the at least one resting portion 36.

The fastener 34 being removably attached to the support body 32, in this example by being passed through a hole 37 in the head portion 40. The head portion 40, is adjoined to a beam support portion 31 when the anchoring portion is interconnected with a channel 44 of the beam supporting rail 30 and the at least one resting portion 36 adjoins a hip 39 of the channel 44, adjoining shown at 35. In FIG. 3 the head portion 40 is shown as being integrally made with the support body 32 however the head portion 40 can be attached by any suitable means dependent upon the particular needs of the user.

There is a clasp 33 attached to the beam support portion 31 interconnecting with the clasp receiving portion 42. The fastener 34 being capable of securing the beam support portion 31., in this example, though not shown, the fastener 34 (shown as a zip tie) would wrap over the head portion 40 and the clasp 33 and then be fastened tightly. The apparatus provides that the clasp 33 can be easily engaged and disengaged from the clasp receiving portion 42 before being fastened by the fastener 34.

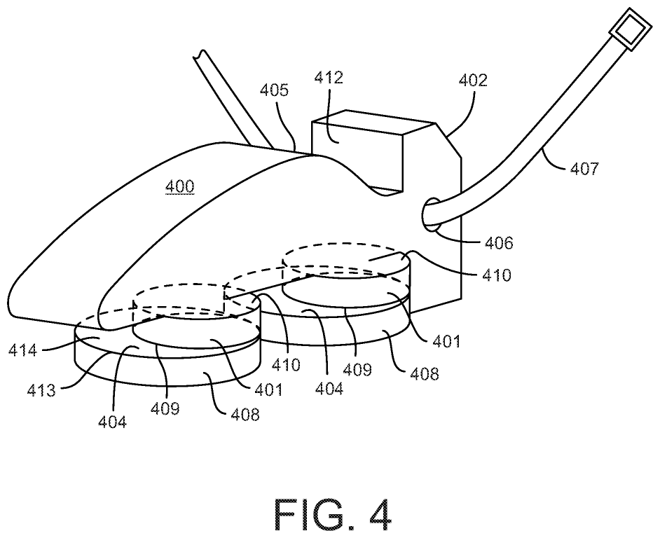

As show in FIG. 4, a perspective view of an embodiment of the present invention comprises a support body 400 with at least one resting portion 401 and at least one anchoring portion 408. The at least one resting portion 401 being attached to the support body 400 and the at least one anchoring portion 408 being attached to the at least one resting portion 401.

The at least one resting portion 401 having a first face 410 and a second face 409. At least one anchoring portion 408 having a third face 404 shown coplanar with the second face 409. There is a fastener 407. The first face 410 being attached to the support body 400. The third face 404 being attached to the second face 409. The support body 400 and the at least one anchoring portion 408 being spaced apart by the at least one resting portion 401. An offset portion 413 having an anchoring surface 414 and being connected to the at least one anchoring portion 408. The anchoring surface 414 extending away from the at least one resting portion 401. The anchoring surface 414 being sufficiently coplanar with the third face 404 and suitable for interconnection to a channel such as is shown in FIG. 3 at 44.

In FIG. 4, the at least one resting portion 401 and the at least one anchoring portion 408 are shown to be cylinders or disks. However, the shape of these can be anything that suits the purpose of attaching the support body to the channel 44 of FIG. 3 or the like. As shown, being a disk, the at least one resting portion 401 has a first face 410 and a second face 409 which are opposite but need not be. And the at least one anchoring portion 408, also shown as disk like, has a third face 404. These faces, or surfaces, allow for a sort of stacking connection where the at least one resting portion 401 is attached to the support body 400 via its first face 410 being adjoined to the support body 400. The at least one anchoring portion 408 is attached by the third face 404 being attached to the second face 409. In my preferred embodiment, the support body 400, the at least one resting portion 401 and the at least one anchoring portion 408 are integrally attached. I envision this being a molded manufacture process where the elements are integrated, though other means for attachment are possible. A clasp, such as that shown in FIG. 3 at 33, would rest on the support body 400 at 405 after interconnecting with a clasp receiving portion 412.

The portions of the apparatus, for instance at least the support body 400, would be made of a durable material sufficiently capable of withstanding the forces exerted against it by a beam support portion. The apparatus could be manufactured per Military Standard MS33601 to meet this durability property.

The fastener 407 being removably attached to the support body 400 by being passable through a hole 406 in the support body 400. The fastener 407 can be attached in many other ways but I found this to be the best way for doing so. The support body 400 having a head portion 402. In a preferred embodiment, the fastener 407 is selected from the group consisting of a zip tie, a hook-and-loop fastener, a metal tie, a cotter, or a string. Of course, other fasteners are possible with the principle purpose being to better secure the support body 400 to a beam support portion such as that shown in FIG. 3 at 31.

Although the present invention has been described in considerable detail with the reference to certain preferred versions thereof, other versions are possible. For example, the support body may be without a clasp retaining portion. Too a fastener need not be included according to the specific circumstance. Also, the beam support rails need not be vertical and could be otherwise positioned such as in a cargo transport plane having floor mounted rails. The invention could work well with beams that are not rigid, ropes or belts for instance. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. § 112, ¶6.

What I claim is:

1. An apparatus for a beam supporting rail, the apparatus comprising:
a support body;
at least one resting portion;
at least one anchoring portion;
the at least one resting portion being attached to the support body;
the at least one anchoring portion being attached to the at least one resting portion;
the support body and the at least one anchoring portion being spaced apart by the at least one resting portion;
the support body, whereby the support body may be adjoined to a beam support portion when the at least one anchoring portion is interconnected with a channel of the beam supporting rail and the at least one resting portion adjoins a hip of the channel.

2. The apparatus of claim 1 further comprising:
the support body having a clasp receiving portion;
the receiving portion, whereby the receiving portion may be interconnected with a clasp attached to the beam support portion.

3. The apparatus of claim 1 wherein the support body adjoins the beam support portion at a head portion which is integrally attached to the support body.

4. The apparatus of claim 1 further comprising:
the at least one resting portion having a first face and a second face;
the at least one anchoring portion having a third face;
the at least one resting portion being attached to the support body via its first face being adjoined to the support body;
the third face being attached to the second face.

5. The apparatus of claim 1 further comprising:
a fastener;
the fastener being removably attached to the support body;
the fastener being capable of securing the beam support portion to the support body.

6. The apparatus of claim 4 further comprising:
an offset portion;
the offset portion having an anchoring surface;
the offset portion being connected to the at least one anchoring portion;
the anchoring surface extending away from the at least one resting portion;
the anchoring surface being sufficiently coplanar with the third face;
the anchoring surface being interconnectable with the channel.

7. An apparatus for a beam supporting rail, the apparatus comprising:
a support body;
the support body having a head portion;
the support body having a clasp receiving portion;
at least one resting portion;
the at least one resting portion having a first face and a second face;
at least one anchoring portion;
the at least one anchoring portion having a third face;
a fastener;
the first face being attached to the support body;
the third face being attached to the second face;
the support body and the at least one anchoring portion being spaced apart by the at least one resting portion;
an offset portion;
the offset portion having an anchoring surface;
the offset portion being connected to the at least one anchoring portion;
the anchoring surface extending away from the at least one resting portion;
the anchoring surface being sufficiently coplanar with the third face;
the fastener being removably attached to the support body;
the head portion, whereby the head portion may be adjoined to a beam support portion when the anchoring surface is interconnected with a channel of the beam supporting rail and the at least one resting portion adjoins a hip of the channel;
a clasp attached to the beam support portion interconnecting with the clasp receiving portion;
the fastener being capable of securing the beam support portion.

8. The apparatus of claim 7 wherein the support body, the at least one resting portion and the at least one anchoring portion are integrally attached.

9. The apparatus of claim 7 wherein the fastener is selected from the group consisting of a zip tie, a hook-and-loop fastener, a metal tie, a cotter, or a string.

10. The apparatus of claim 7 further comprising the fastener passing through a hole in the support body.

11. The apparatus of claim 7 wherein the support body is made of a durable material sufficiently capable of withstanding the forces exerted against it by the beam support portion.

12. The apparatus of claim 7 wherein the apparatus is manufactured per Military Standard MS33601.

13. An apparatus for a beam supporting rail, the apparatus comprising:
a support body;
the support body having a head portion;
the support body having a clasp receiving portion;
at least one resting portion;
the at least one resting portion having a first face and a second face;
at least one anchoring portion;
the at least one anchoring portion having a third face;
a fastener;
the first face being attached to the support body;
the third face being attached to the second face;
the support body and the at least one anchoring portion being spaced apart by the at least one resting portion;
an offset portion;
the offset portion having an anchoring surface;
the offset portion being connected to the at least one anchoring portion;
the anchoring surface extending away from the at least one resting portion;
the anchoring surface being sufficiently coplanar with the third face;
the fastener being removably attached to the support body;
the head portion, whereby the head portion may be adjoined to a beam support portion when the anchoring surface is interconnected with a channel of the beam supporting rail and the at least one resting portion adjoins a hip of the channel;
a clasp attached to the beam support portion interconnecting with the clasp receiving portion;
the fastener being capable of securing the beam support portion;
the at least one resting portion and the at least one anchoring portion being integrally attached;
the fastener being selected from the group consisting of a zip tie, a hook-and-loop fastener, a metal tie, a cotter, or a string;
the fastener passing through a hole in the support body;
the support body being manufactured per Military Standard MS33601.
